(19) United States
(12) Patent Application Publication
(10) Pub. No.: US 2025/0362534 A1
(43) Pub. Date: Nov. 27, 2025

(54) DISPLAY DEVICE

(71) Applicants: Innolux Corporation, Miaoli County (TW); CARUX TECHNOLOGY PTE. LTD., SINGAPORE (SG)

(72) Inventors: Li-Wei Sung, Tainan (TW); Hong-Sheng Hsieh, Miaoli County (TW); Yu-Ti Huang, Miaoli County (TW); Jyun-Sian Li, Miaoli County (TW)

(73) Assignees: Innolux Corporation, Miaoli County (TW); CARUX TECHNOLOGY PTE. LTD., SINGAPORE (SG)

(21) Appl. No.: 19/193,995

(22) Filed: Apr. 30, 2025

(30) Foreign Application Priority Data
May 21, 2024 (CN) 202410630273.8

(51) Int. Cl. G02F 1/13; G02F 1/1362

(52) U.S. Cl. CPC G02F 1/1323; G02F 1/136209; G02F 1/136286

(57) ABSTRACT

A display device includes a display panel, a viewing angle control panel and a first polarizing plate. The display panel includes a data line, a scan line and a first electrode. The data line extends along a first direction. The scan line extends along a second direction and intersecting with the data line. The first electrode has a plurality of fingers, wherein the plurality of fingers are arranged along the first direction. The viewing angle control panel overlaps the display panel. The first polarizing plate is disposed on a surface opposite to a light-emitting surface of the display panel and having a first absorption axis, wherein the first absorption axis is parallel to the first direction.

### CROSS-REFERENCE TO RELATED APPLICATION

This application claims the priority benefit of China application serial no. 202410630273.8, filed on May 21, 2024. The entirety of the above-mentioned patent application is hereby incorporated by reference herein and made a part of this specification.

### BACKGROUND

### Technical Field

The disclosure relates to a display device, particularly a display device applied to a vehicle display.

### Description of Related Art

When the display device is applied in privacy electronic products, there is a need to extend the privacy viewing angle in terms of specifications. For example, the privacy viewing angle of the screen of a vehicle display is required to be about 30° to about 60°. However, the existing privacy designs of vehicle displays have inferior privacy capability at relatively small viewing angles (for example, less than 45°).

### SUMMARY

The disclosure provides a display device that has relatively good privacy capability at a small viewing angle.

The display device provided according to some embodiments of the disclosure includes a display panel and a viewing angle control panel. The display panel includes a light-shielding layer, and the light-shielding layer has multiple opening regions. At least one of the multiple opening regions has two first edges, and the two first edges correspond to each other and extend along a first direction. The viewing angle control panel overlaps the display panel and has a direction of liquid crystal director. An angle between the direction of liquid crystal director and the first direction is from −25° to 25° or from 155° to 205°. One of the two first edges has a first length, a spacing between the two first edges is a first distance, and the first length is less than the first distance.

The display device provided according to some embodiments of the disclosure includes a display panel, a viewing angle control panel and a first polarizing plate. The display panel includes a data line, a scan line and a first electrode. The data line extends along a first direction. The scan line extends along a second direction and intersecting with the data line. The first electrode has a plurality of fingers, wherein the plurality of fingers are arranged along the first direction. The viewing angle control panel overlaps the display panel. The first polarizing plate is disposed on a surface opposite to a light-emitting surface of the display panel and having a first absorption axis, wherein the first absorption axis is parallel to the first direction.

In order to make the above features and advantages of the disclosure more obvious and understandable, embodiments are given below and described in detail with reference to the accompanying drawings.

### BRIEF DESCRIPTION OF THE DRAWINGS

FIG. 1 is an exploded perspective schematic diagram of a display device of the first embodiment of the disclosure.

FIG. 2A is an embodiment of a direction of liquid crystal director of a viewing angle control panel in the display device shown in FIG. 1.

FIG. 2B is another embodiment of a direction of liquid crystal director of a viewing angle control panel in the display device shown in FIG. 1.

FIG. 3A is a partial top schematic diagram of an embodiment of a region R according to FIG. 1.

FIG. 3B is an enlarged schematic diagram of an embodiment according to FIG. 3A.

FIG. 3C is an enlarged schematic diagram of another embodiment according to FIG. 3A.

FIG. 4 is a graph showing a relationship between a viewing angle of a display device of an embodiment of the disclosure and a luminance ratio.

FIG. 5A is a schematic diagram of a vehicle display including a display device of an embodiment of the disclosure.

FIG. 5B shows a schematic diagram of an embodiment of a direction of liquid crystal director of a viewing angle control panel in a vehicle display.

FIG. 5C shows a schematic diagram of another embodiment of a direction of liquid crystal director of a viewing angle control panel in a vehicle display.

FIG. 6 is an exploded perspective schematic diagram of a display device of the second embodiment of the disclosure.

FIG. 7 is a partial top schematic diagram of another embodiment of the region R according to FIG. 1.

FIG. 8 is an exploded perspective schematic diagram of a display device of the third embodiment of the disclosure.

FIG. 9 is a curve diagram showing a relationship between a viewing angle of the display device and a luminance ratio in an E-mode structure and an O-mode structure according to an embodiment of the disclosure.

### DESCRIPTION OF THE EMBODIMENTS

Reference will now be made in detail to the exemplary embodiments of the disclosure, and examples of the exemplary embodiments are illustrated in the drawings. Wherever possible, the same reference numerals are used in the drawings and the description to refer to the same or similar parts.

The disclosure can be understood by referring to the following detailed description in conjunction with the drawings. It should be noted that in order to facilitate the understanding of the reader and the brevity of the drawings, multiple drawings in the disclosure only depict a part of an electronic device, and specific elements in the drawings are not drawn according to actual scale. In addition, the number and the size of each element in the drawings are for illustration only and are not intended to limit the scope of the disclosure.

Throughout the specification and the appended claims of the disclosure, certain terms may be used to refer to specific elements. It should be understood by persons skilled in the art that electronic device manufacturers may refer to the same element by different names. The disclosure does not intend to distinguish between elements with the same function but different names. In the following specification and claims, terms such as “including”, “containing”, and “having” are open-ended terms, so the terms should be interpreted as “containing but not limited to . . . ” Therefore, when the terms “including”, “containing”, and/or “having” are used in the description of the disclosure, the terms designate the presence of a corresponding feature, region, step, operation, and/or component, but do not exclude the presence of one or more corresponding features, regions, steps, operations, and/or components.

Directional terms such as “upper”, “lower”, “front”, “rear”, “left”, and “right” mentioned in the disclosure are only directions with reference to the drawings. Therefore, the used directional terms are used to illustrate, but not to limit, the disclosure. In the drawings, each drawing illustrates the general features of a method, a structure, and/or a material used in a specific embodiment. However, the drawings should not be construed to define or limit the scope or nature covered by the embodiments. For example, for clarity, relative sizes, thicknesses, and positions of various film layers, regions, and/or structures may be reduced or enlarged.

When a corresponding component (for example, a film layer or a region) is referred to as being “on another component”, the component may be directly on the other component or there may be another component between the two. On the other hand, when a component is referred to as being “directly on another component”, there is no component between the two. In addition, when a component is referred to as being “on another component”, the two have an upper-lower relationship in the top view direction, and the component may be above or below the other component, and the upper-lower relationship depends on the direction of the device.

The terms “equal” or “same”, “substantially”, or “roughly” are generally interpreted as within 20% of a given value or range or interpreted as within 10%, 5%, 3%, 2%, 1%, or 0.5% of the given value or range.

Ordinal numbers such as “first” and “second” used in the specification and the claims are used to modify elements, and the terms do not imply and represent that the element(s) have any previous ordinal numbers, nor do they represent the order of a certain element and another element or the order of a manufacturing method. The use of the ordinal numbers is only to clearly distinguish between an element with a certain name and another element with the same name. The claims and the specification may not use the same terms, whereby a first component in the specification may be a second component in the claims.

It should be noted that in the following embodiments, features in several different embodiments may be replaced, recombined, and mixed to complete other embodiments without departing from the spirit of the disclosure. As long as the features of the various embodiments do not violate the spirit of the disclosure or conflict with each other, the features may be arbitrarily mixed and matched for use.

Electrical connection or coupling described in the disclosure may refer to direct connection or indirect connection. In the case of direct connection, terminals of elements on two circuits are directly connected or connected to each other by a conductor segment. In the case of indirect connection, there is a switch, a diode, a capacitor, an inductor, other suitable elements, or a combination of the above elements between the terminals of the elements on the two circuits, but not limited thereto.

In the disclosure, the thickness, length, width, and area may be measured by adopting an optical microscope, and the thickness may be obtained by measuring a cross-sectional image in an electron microscope, but not limited thereto. In addition, there may be a certain error in any two values or directions for comparison. If a first value is equal to a second value, it implies that there may be an error of about 10% between the first value and the second value. If a first direction is perpendicular to a second direction, an angle between the first direction and the second direction may be between 80 degrees and 100 degrees; and if the first direction is parallel to the second direction, the angle between the first direction and the second direction may be between 0 degrees and 10 degrees.

The display device described in the disclosure may be a non-self-luminous display device or a self-luminous display device, and may be a double-sided display device. The display device may include, for example, diode, liquid crystal, a light-emitting diode (LED), quantum dot (QD), fluorescence, phosphor, other suitable display media, or a combination of the above, but not limited thereto. The light-emitting diodes may include, for example, an organic light-emitting diode (OLED), a mini LED, a micro LED, or a quantum dot LED (QDLED), but not limited thereto. It should be noted that the display device may be any permutation and combination of the above, but not limited thereto. In addition, the appearance of the display device may be a rectangle, a circle, a polygon, a shape with curved edges, or other suitable shapes. The display device may have a peripheral system such as a driving system, a control system, and a light source system.

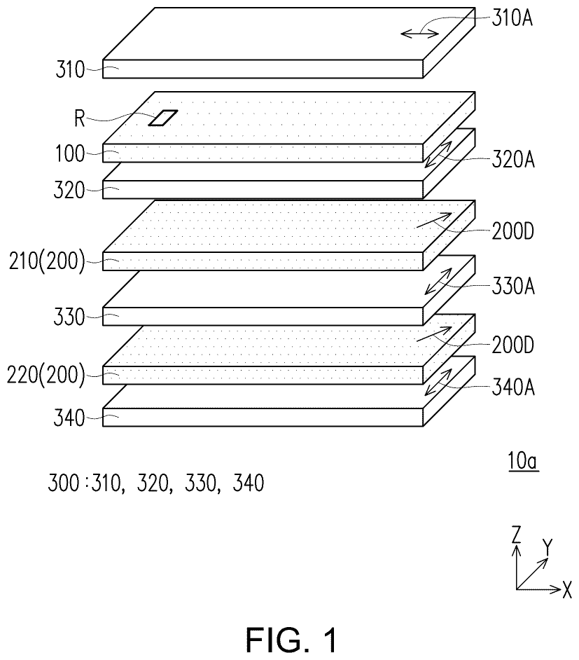

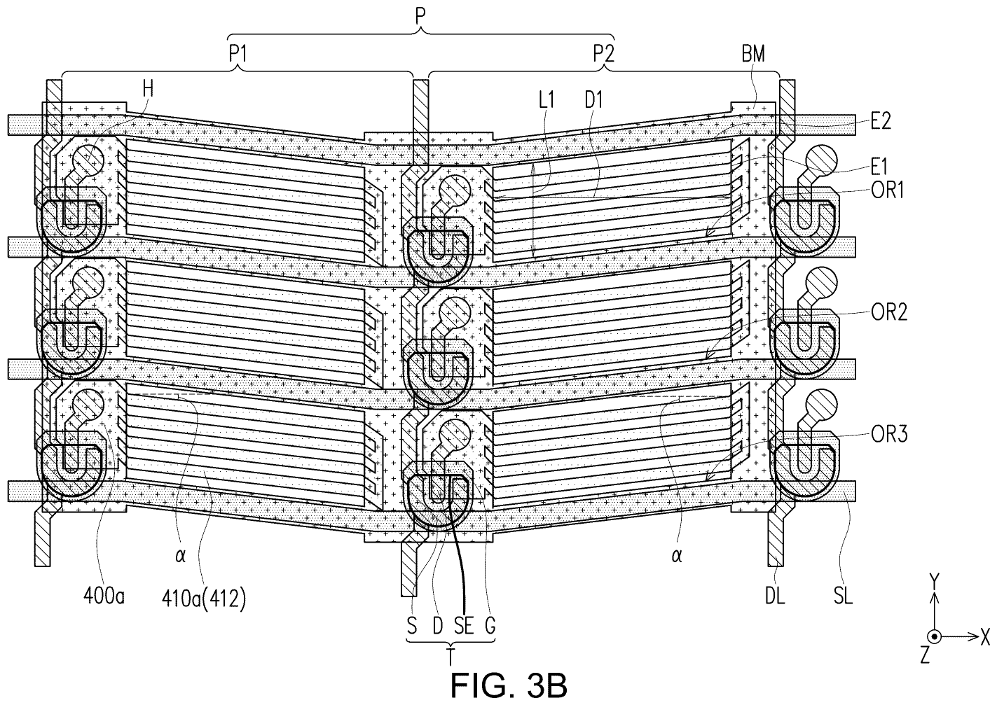

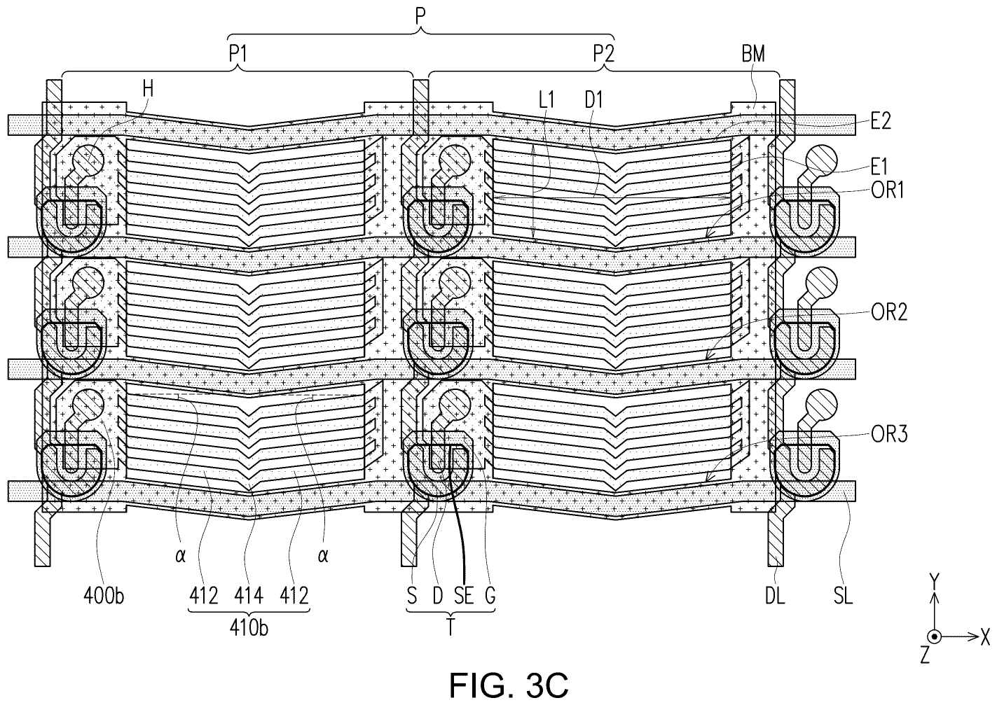

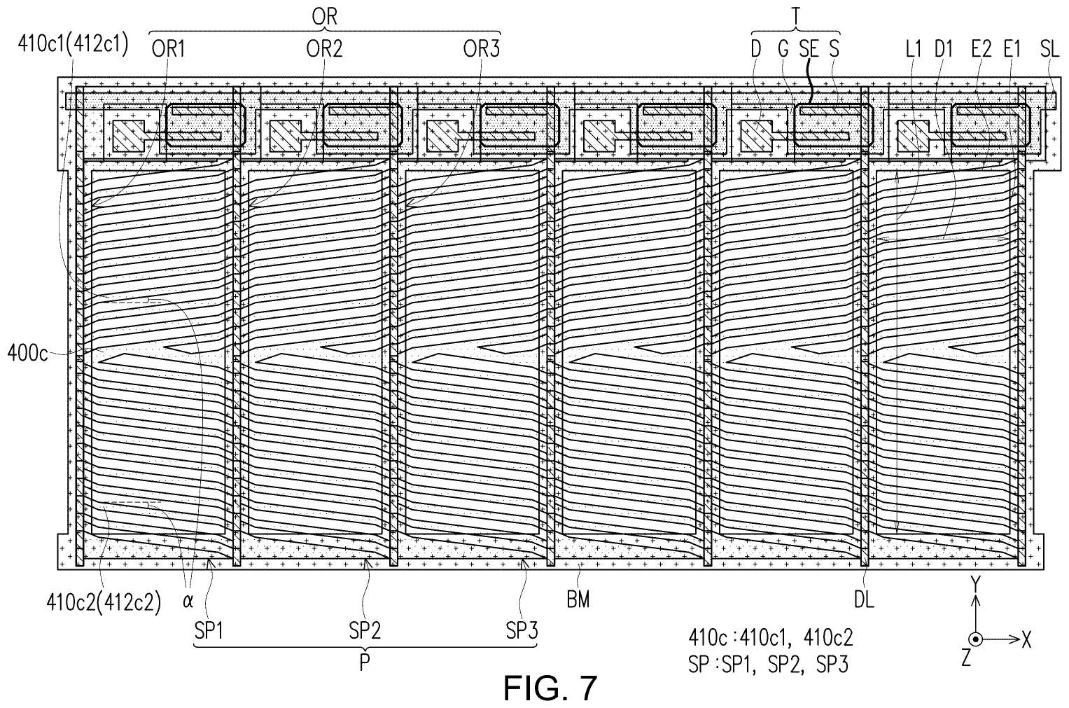

FIG. 1 is an exploded perspective schematic diagram of a display device of the first embodiment of the disclosure. The region R of the display panel 100 may refer to the partial enlarged schematic diagrams of FIG. 3A to FIG. 3C and FIG. 7, and will not be described in detail herein.

Please refer to FIG. 1. The display device 10a of the embodiment includes a display panel 100 and a viewing angle control panel 200. The display panel 100 emits light toward, for example, a direction Z to display an image. The viewing angle control panel 200 overlaps, for example, the display panel 100, and can be disposed to have one or more viewing angle control panels. In the embodiment, taking two viewing angle control panels (that is, the first viewing angle control panel 210 and the second viewing angle control panel 220 in FIG. 1) as an example, the first viewing angle control panel 210 is disposed between the display panel 100 and the second viewing angle control panel 220 in the direction Z, but the disclosure is not limited thereto. The display panel 100 may be, for example, a self-luminous display panel or a non-self-luminous display panel, and the disclosure is not limited thereto. In the embodiment, the display panel 100 and the viewing angle control panel 200 each include different liquid crystal display panels.

Please continue to refer to FIG. 1. In the embodiment, the display device 10a may further include a polarizing plate 300. The polarizing plate 300 includes, for example, a first polarizing plate 310, a second polarizing plate 320, a third polarizing plate 330, and a fourth polarizing plate 340.

The first polarizing plate 310 is, for example, disposed on the light-emitting surface of the display panel 100. In some embodiments, the first polarizing plate 310 may include a reflective polarizing plate or an absorptive polarizing plate. The first polarizing plate 310 may, for example, have a sandwich structure or a stacked structure. For example, the first polarizing plate 310 may have polarizers (not shown) and protective layers (not shown) disposed on opposite surfaces of the polarizers, but the disclosure is not limited thereto. The polarizers, for example, is films with properties such as light transmission and light deflection, and the protective layers are, for example, configured to support and protect the polarizers to increase the mechanical strength of the first polarizing plate 310. In some embodiments, the material of the polarizers may include polyvinyl alcohol (PVA), and the material of the protective layers may include tri-acetyl cellulose (TAC), poly (methyl methacrylate) (acrylic) or polyethylene terephthalate, but the disclosure is not limited thereto. In the embodiment, the absorption axis 310A of the first polarizing plate 310 is parallel to a direction X, but the disclosure is not limited thereto.

The second polarizing plate 320 is, for example, disposed on the surface of the display panel 100 opposite to the light-emitting surface. In other words, the second polarizing plate 320 and the first polarizing plate 310 are, for example, disposed on opposite surfaces of the display panel 100.

The third polarizing plate 330 is, for example, disposed on the surface of the first viewing angle control panel 210 away from the display panel 100. In other words, the first viewing angle control panel 210 is, for example, disposed between the third polarizing plate 330 and the display panel 100.

The fourth polarizing plate 340 is, for example, disposed on the surface of the second viewing angle control panel 220 away from the display panel 100. In other words, the second viewing angle control panel 220 is, for example, disposed between the fourth polarizing plate 340 and the display panel 100.

The structures and materials of the second polarizing plate 320, the third polarizing plate 330, and the fourth polarizing plate 340 may be the same as or similar to the structure and materials of the first polarizing plate 310, which will not be described again here.

In the disclosure, the polarizing plates located on different sides (or opposite surfaces) of the display panel have absorption axes that are perpendicular to each other, and the polarizing plates located on the same side (or the same surface) of the display panel have absorption axes that are parallel to each other. In the embodiment, since the first polarizing plate 310 is located on the light-emitting surface of the display panel, the second polarizing plate 320, the third polarizing plate 330, and the fourth polarizing plate 340 are located on the surface of the display panel opposite to the light-emitting surface. Therefore, the absorption axis 310A of the first polarizing plate 310 is perpendicular to the absorption axis 320A of the second polarizing plate 320, the absorption axis 330A of the third polarizing plate 330, and the absorption axis 340A of the fourth polarizing plate 340. In addition, the absorption axis 320A of the second polarizing plate 320, the absorption axis 330A of the third polarizing plate 330, and the absorption axis 340A of the fourth polarizing plate 340 are parallel to each other. In the embodiment, the absorption axis 320A of the second polarizing plate 320, the absorption axis 330A of the third polarizing plate 330, and the absorption axis 340A of the fourth polarizing plate 340 are parallel to a direction Y, but the disclosure is not limited thereto.

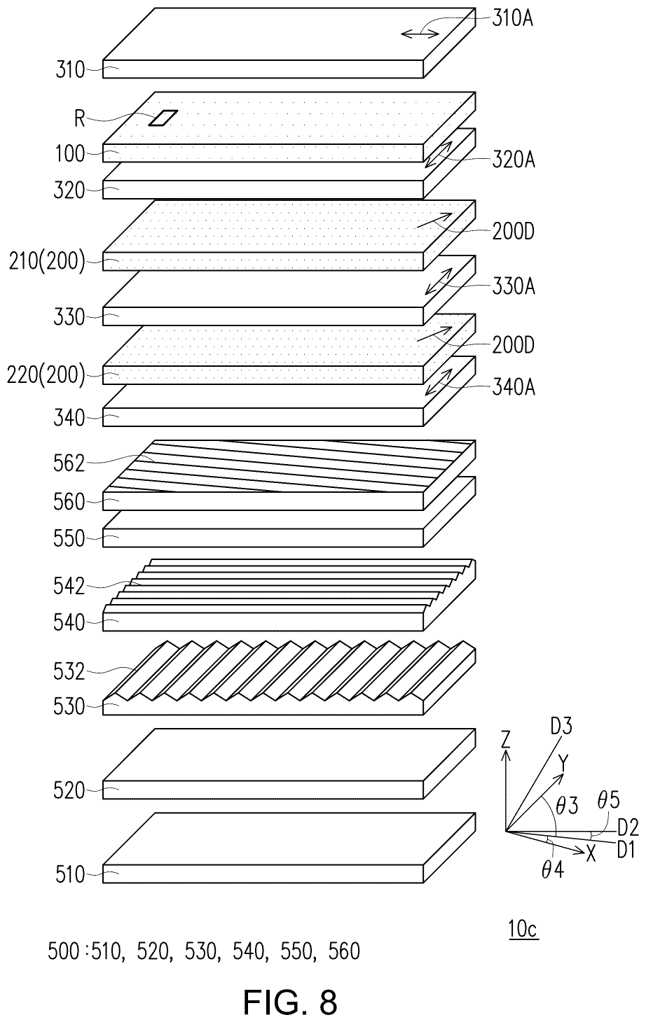

In the embodiment, that is, in a condition where the display panel 100 and the viewing angle control panel 200 are non-self-luminous display panels, the display device 10a may further include a backlight module (not shown). The backlight module is disposed on a side of the display panel 100 opposite to the light-emitting surface. Furthermore, the first polarizing plate 310, the display panel 100, the second polarizing plate 320, the first viewing angle control panel 210, the third polarizing plate 330, the second viewing angle control panel 220, and the fourth polarizing plate 340 are all arranged on the backlight module. In the embodiment, the backlight module is disposed on the surface of the fourth polarizing plate 340 away from the second viewing angle control panel 220, but the disclosure is not limited thereto. The following FIG. 8 would introduce the relevant descriptions of the backlight module.

In addition, in a condition where the display panel 100 is a non-self-luminous display panel, the display panel 100 and the viewing angle control panel 200 may, for example, have different phase delays. In detail, a liquid crystal layer (not shown) of the display panel 100 has a first liquid crystal birefringence difference and a first liquid crystal cell gap, and a liquid crystal layer (not shown) of the viewing angle control panel 200 has a second liquid crystal birefringence. difference and a second liquid crystal cell gap, wherein the product of the first liquid crystal birefringence difference and the first liquid crystal cell gap is different from the product of the second liquid crystal birefringence difference and the second liquid crystal cell gap. In some embodiments, the phase delay of the display panel 100 is smaller than the phase delay of the viewing angle control panel 200, but the disclosure is not limited thereto.

In the embodiment, the viewing angle control panel 200 has a direction of liquid crystal director 200D, wherein the angle θ between the direction of liquid crystal director 200D and the direction Y is from −25° (calculated from the direction Y rotating along the clockwise direction until the direction of liquid crystal director 200D) to 25° (calculated from the direction Y rotating along the counterclockwise direction until the direction of liquid crystal director 200D) (−25°≤θ≤25°) or from 155° (calculated from the direction Y rotating along the counterclockwise direction until the direction of liquid crystal director 200D) to 205° (calculated from direction Y rotating along the counterclockwise direction until the direction of liquid crystal director 200D) (155°≤0≤205°). In the present disclosure, it should be understood the angle rotated along the clockwise direction is a negative value, and the angle rotated in the counterclockwise direction is a positive value. For example, the positive value and the negative value of the angle θ between the direction of liquid crystal director 200D and the direction Y are based on the direction Y. When the direction Y is rotated clockwise until the direction of liquid crystal director 200D, the angle θ is the negative value; conversely, when the direction Y is rotated counterclockwise until the direction of liquid crystal director 200D, the angle θ is the positive value. In the present embodiment, the applicable range of the angle θ may vary with the type of liquid crystal. For example, when using a vertical alignment (VA) liquid crystal architecture, the angle θ ranges from −25° to 25° or 155° to 205°, and when using an electrically controlled birefringence (ECB) liquid crystal architecture, the angle θ ranges from −15° to 15° or from 165° to 195°, but not limited thereto.

In detail, the viewing angle control panel 200 may be, for example, an electronically controlled viewing angle control liquid crystal panel. For example, the structure of the viewing angle control panel 200 may include an active component array substrate (not shown), another substrate (not shown), a liquid crystal layer (not shown) disposed between the active component array substrate and the another substrate, two transparent electrode layers (not shown) disposed on two sides of the liquid crystal layer, a first alignment layer (not shown) and a second alignment layer (not shown) respectively disposed between the liquid crystal layer and the two transparent electrode layers, wherein the first alignment layer is relatively close to the active component array substrate, and the second alignment layer is relatively close to the another substrate. In the present embodiment, the two transparent electrode layers disposed on both sides of the liquid crystal layer are full-surface electrodes. By changing the voltage between the two transparent electrode layers, the penetration of light in the liquid crystal layer may be adjusted and changed, so that the viewing angle control panel 200 has a viewing angle switching effect. Based on this, the viewing angle control panel 200 may provide electrical signal control so that the display device 10a may switch between a share mode and a privacy mode. In the embodiment, the display device 10a can switch between the share mode and the privacy mode in the direction X.

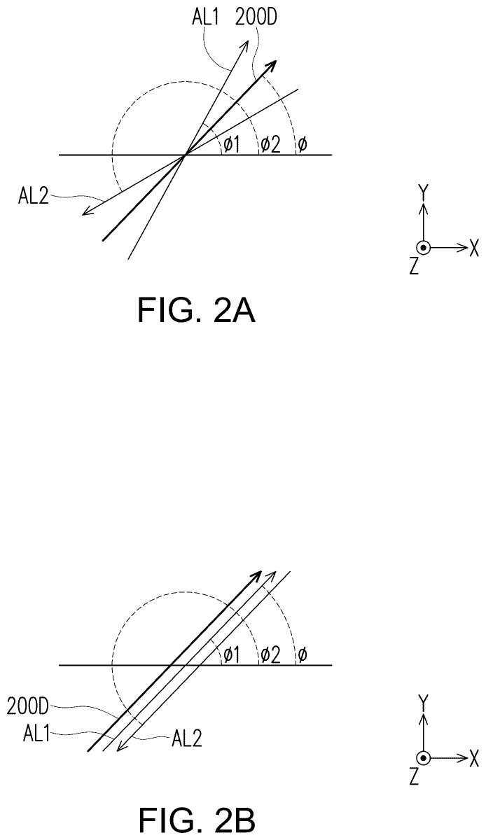

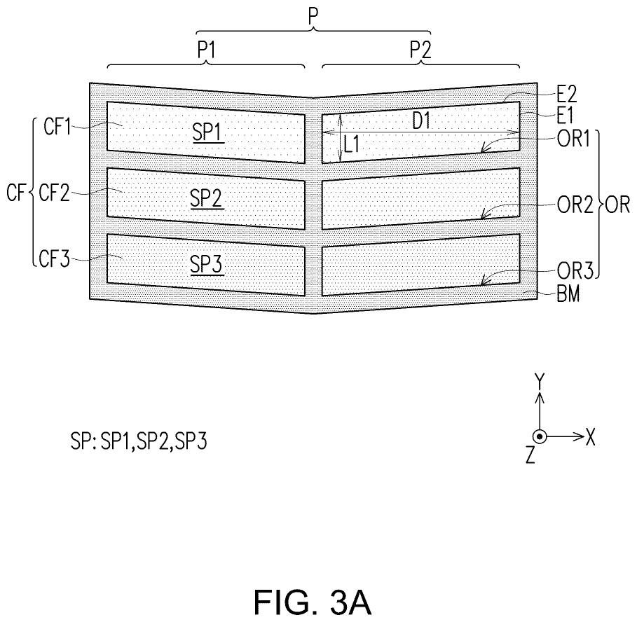

The direction of liquid crystal director 200D of the viewing angle control panel 200 may be defined by, for example, the first alignment layer and the second alignment layer. Please refer to FIG. 2A. FIG. 2A shows that there is an angle Ø1 between an alignment direction AL1 of the first alignment layer (the alignment layer close to the active component array substrate) and the direction X (the angle obtained by rotating the direction X counterclockwise to the alignment direction AL1, wherein 0°<Ø1<360°), and there is an angle Ø2 between the alignment direction AL2 of the second alignment layer (the alignment layer close to the another substrate) and the direction X (the angle obtained by turning the direction X counterclockwise to the alignment direction AL2, wherein 0°<Ø2<360°), and the angle Ø between the direction of liquid crystal director 200D and the direction X may be defined as Ø1+((Ø2−180°)−Ø1)/2. For example, the angle Ø1 between the alignment direction AL1 of the first alignment layer and the direction X is 70 degrees, the angle Ø2 between the alignment direction AL2 of the second alignment layer and the direction X is 240 degrees, and the angle Ø between the direction of liquid crystal director 200D and the direction X is 65 degrees. For another example, the angle Ø1 between the alignment direction AL1 of the first alignment layer and the direction X is 60 degrees, the angle Ø2 between the alignment direction AL2 of the second alignment layer and the direction X is 250 degrees, and the angle Ø between the direction of liquid crystal director 200D and the direction X is 65 degrees.

Please refer to FIG. 2B, which shows that the same direction of liquid crystal director 200D as FIG. 2A may be defined by different alignment direction AL1 and alignment direction AL2; however, the disclosure is not limited to the definition of the direction of liquid crystal director 200D shown in FIG. 2A and FIG. 2B. For example, the angle Ø1 between the alignment direction AL1 of the first alignment layer and the direction X is 65 degrees, the angle Ø2 between the alignment direction AL2 of the second alignment layer and the direction X is 245 degrees, and the angle Ø between the direction of liquid crystal director 200D and the direction X is 65 degrees.

FIG. 3A is a partial top schematic diagram of an embodiment of a region R according to FIG. 1, and FIG. 3B is an enlarged schematic diagram of an embodiment according to FIG. 3A.

Please refer to FIG. 3A. In the embodiment, the display panel 100 includes a light-shielding layer BM. The light-shielding layer BM may, for example, have multiple opening regions OR. In detail, the light-shielding layer BM may be disposed to have a grid structure to define the multiple opening regions OR. In some embodiments, the material of the light-shielding layer BM may include black resin, black photoresist, metal, or a combination thereof. The light-shielding layer BM may be configured to have the functions of absorbing a portion of the light, blocking a portion of the light, and/or shielding the elements and wirings inside the display device 10a. In the embodiment, the display panel 100 further includes a filter layer CF, so that the display device 10a may display a color display screen. The filter layer CF is, for example, disposed in the multiple opening regions OR of the light-shielding layer BM. In some embodiments, the filter layer CF includes a red filter layer CF1, a green filter layer CF2, and a blue filter layer CF3, but the disclosure is not limited thereto. In other embodiments, the filter layer CF may include filter layers of other colors.

From another perspective, the display panel 100 includes, for example, multiple pixels P, wherein FIG. 3A takes pixel P1 and pixel P2 as an example, but the disclosure is not limited thereto. At least one of the multiple pixels P includes, for example, multiple subpixels SP. Taking pixel P1 shown in FIG. 3A as an example, in the embodiment, pixel P1 includes a first subpixel SP1, a second subpixel SP2, and a third subpixel SP3. The first subpixel SP1, the second subpixel SP2, and the third subpixel SP3 are disposed corresponding to the multiple opening regions OR of the light-shielding layer BM. In detail, the multiple opening regions OR may include a first opening region OR1, a second opening region OR2, and a third opening region OR3 arranged along the direction Y. The first opening region OR1 is disposed corresponding to the first subpixel SP1, the second opening region OR2 is disposed corresponding to the second subpixel SP2, and the third opening region OR3 is disposed corresponding to the third subpixel SP3. Based on this, the first subpixel SP1, the second subpixel SP2, and the third subpixel SP3 are also arranged along the direction Y. As described in the above embodiments, the first subpixel SP1, the second subpixel SP2, and the third subpixel SP3 may emit light of different colors between each other. In some embodiments, the first subpixel SP1, the second subpixel SP2, and the third subpixel SP3 may respectively emit red, green and blue colors, but the disclosure is not limited thereto. In some embodiments, the first subpixel SP1, the second subpixel SP2, and the third subpixel SP3 may have the same area and/or shape between each other, but the disclosure is not limited thereto. In other embodiments, the first subpixel SP1, the second subpixel SP2, and the third subpixel SP3 may have different areas between each other. For example, the area of the second subpixel SP2 may be larger than the area of the first subpixel SP1, and the area of the second subpixel SP2 may be larger than the area of the third subpixel SP3.

In the embodiment, at least one of the plurality of opening regions OR of the light-shielding layer BM has two first edges E1 and two second edges E2, the two first edges E1 correspond to each other, and the two second edges E2 correspond to each other. From a macro perspective, the two first edges E1 extend along the direction Y, and the two second edges E2 extend along the direction Y, but the disclosure is not limited thereto. Taking the first opening region OR1 shown in FIG. 3A as an example, one of the two first edges E1 has a first length L1, for example, and the spacing between the two first edges E1 is, for example, a first distance D1. In the embodiment, the first length L1 is less than the first distance D1. Based on this, in the embodiment, each subpixel among the multiple pixels P included in the display panel 100 is vertically arranged in the direction Y. By vertically arranging each subpixel of the multiple pixels P included in the display panel 100, the privacy capability of the display device 10a may be increased. The reason will be described in detail in the following embodiments.

In the embodiment, the first length L1 is greater than or equal to 10 μm, and less than or equal to 70 μm. For example, the first length L1 may be, for example, 10 μm, 25 μm, 35 μm, 50 μm, 70 μm, or other values in the range of 10 μm to 70 μm.

In the embodiment, the first distance D1 (the distance between the two first edges E1) is greater than or equal to 30 μm, and less than or equal to 210 μm. For example, the first distance D1 may be, for example, 30 μm, 80 μm, 120 μm, 150 μm, 210 μm, or other values in the range of 30 μm to 210 μm.

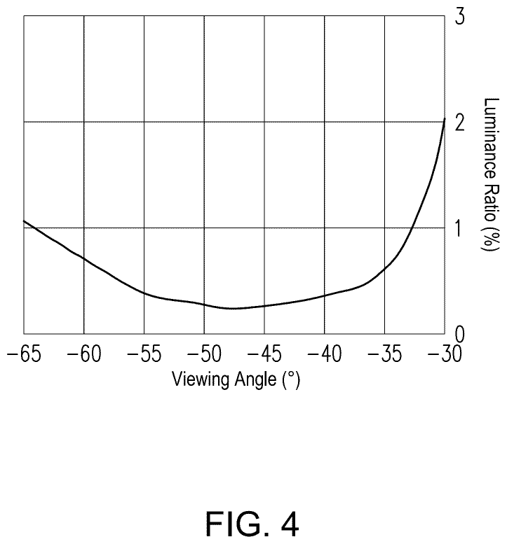

In detail, please refer to FIG. 4. FIG. 4 shows a graph showing a relationship between a viewing angle of the display device 10a and a luminance ratio, wherein the luminance ratio is defined as the percentage of the luminance of the display device 10a measured or viewed at the certain viewing angle in the privacy mode to the luminance of the display device 10a measured or viewed at the normal viewing angle perpendicular to the display device (direction Z). For example, when viewing or measuring at the left side (in the direction opposite to the direction X) of the normal viewing angle of the display device 10a, the viewing angle can be expressed as a negative value, and when viewing or measuring at the right side (the direction X) of the normal viewing angle of the display device 10a, the viewing angle can be expressed as a positive value. In the embodiment for viewing or measuring at the left side (in the direction opposite to the direction X) of the normal viewing angle of the display device 10a, the display device 10a has a viewing angle at a minimum luminance is about 48°, a luminance ratio is less than 1% at a viewing angle from about 33° to about 64°, and a luminance ratio is less than 0.5% at a viewing angle from about 36° to about 57°, but the disclosure is not limited to this. The main reason is that each subpixel in the multiple pixels P is arranged vertically, and each of the multiple pixels P corresponds to only two portions of the light-shielding layer BM in the direction X, so each of the multiple pixels P has one single diffraction source in the direction X, which may reduce the scattering phenomenon caused by the diffraction of the multiple pixels P, thereby increasing the privacy capability of the display device 10a.

Referring to FIG. 3B, in the embodiment, the display panel 100 may further include multiple transistors T, multiple scan lines SL, multiple data lines DL, and a first electrode 400a.

One of the multiple transistors T includes, for example, a gate G, a source S, a drain D, and a semiconductor layer SE, wherein the semiconductor layer SE is, for example, disposed between the gate G and the source S, and the drain D. However, the disclosure is not limited thereto. The material of the semiconductor layer SE may include, for example, low temperature polysilicon (LTPS), metal oxide, amorphous silicon (a-Si) or combinations thereof, but the disclosure is not limited thereto. For example, the material of the semiconductor layer SE may include, but is not limited to, amorphous silicon, polycrystalline silicon, germanium, compound semiconductors (such as gallium nitride, silicon carbide, gallium arsenide, gallium phosphide, indium phosphide, indium arsenide and/or indium antimonide), alloy semiconductors (such as SiGe alloy, GaAsP alloy, AlInAs alloy, AlGaAs alloy, GaInAs alloy, GalnP alloy, GaInAsP alloy), or a combination of the above. The material of the semiconductor layer SE may also include, but is not limited to, metal oxides, such as indium gallium zinc oxide (IGZO), indium zinc oxide (IZO), indium gallium zinc oxide (IGZTO), or organic semiconductors that include polycyclic aromatic compounds, or a combination of the above. In the embodiment, the material of the semiconductor layer SE is amorphous silicon, but the disclosure is not limited thereto. The gate G, for example, at least partially overlaps with the semiconductor layer SE. The source S and the drain D are, for example, segregated from each other, cover at least part of the semiconductor layer SE and are electrically connected to the semiconductor layer SE.

From a macro perspective, the multiple scan lines SL, for example, substantially extend in the direction X, and the multiple data lines DL, for example, extend in the direction Y, and the direction X is perpendicular to the direction Y. In the embodiment, two adjacent scan lines SL and two adjacent data lines DL may define a subpixel SP of the display device 10a, but the disclosure is not limited thereto. The gate G of one of the multiple transistors T may, for example, be electrically connected to the corresponding scan line SL to receive corresponding scan signal, and the source S of one of the multiple transistors T may, for example, be electrically connected to the corresponding data line DL to receive corresponding data signals. In some embodiments, the materials of the scan line SL and the data line DL may each include molybdenum (Mo), titanium (Ti), tantalum (Ta), niobium (Nb), hafnium (Hf), nickel (Ni), chromium (Cr), cobalt (Co), zirconium (Zr), tungsten (W), aluminum (Al), copper (Cu), silver (Ag), other suitable metals, or alloys or combinations of the above materials, and the disclosure is not limited thereto. The scan line SL and the data line DL may, for example, include the same or different materials, and the disclosure is not limited thereto.

The first electrode 400a is electrically connected to the transistor T. In the embodiment, the first electrode 400a may be used as a pixel electrode, and is electrically connected to the drain D of the transistor T through a contact hole H, but the disclosure is not limited thereto. In other embodiments, the first electrode 400a may be used as a common electrode. The material of the first electrode 400a may, for example, include metal oxide conductive materials (for example, indium tin oxide, indium zinc oxide, aluminum tin oxide, aluminum zinc oxide, indium germanium zinc oxide), but the disclosure is not limited thereto.

In the embodiment, the first electrode 400a has multiple fingers 410a. The multiple fingers 410a are, for example, arranged along the direction Y. In some embodiments, at least one of the multiple fingers 410a has a strip region 412. The extension direction of the strip region 412 is, for example, parallel to at least one of the multiple scan lines SL. In addition, the extension direction of the strip region 412 is also, for example, parallel to the extension direction of the second edge E2 of the corresponding opening region OR, but the disclosure is not limited thereto. In the embodiment, an absolute value of the angle α between the extension direction of the strip region 412 and the direction X ranges from 3° to 15° (3°≤|α|≤15°), and the strip regions of fingers corresponding to different pixels or subpixels have the different extension directions, but the disclosure is not limited thereto. For example, the angle α between the extension direction of the strip regions 412 of the plurality of fingers 410a corresponding to the pixel P1 or the subpixel of the pixel P1 and the direction X ranges from −3° to −15° (calculated from the direction X rotating along the clockwise direction until the extension direction of the strip region 412), and the angle α between the extension direction of the strip regions 412 of the plurality of fingers 410a corresponding to the pixel P2 or the subpixel of the pixel P2 and the direction X ranges from 3° to 15° (calculated from the direction X rotating along the counterclockwise direction until the extension direction of the strip region 412). In some embodiments, an absolute value of the angle α between the extension direction of the strip region 412 of the plurality of fingers 410 corresponding to the pixel P2 or the subpixel of the pixel P2 and the direction X is 7°, but the disclosure is not limited thereto.

FIG. 3C is an enlarged schematic diagram of another embodiment according to FIG. 3A. It should be noted that the embodiment of FIG. 3C can use the reference numbers and part of the content of the embodiment of FIG. 3B, wherein the same or similar numbers are used to represent the same or similar elements, and the description of the same technical content is omitted.

Referring to FIG. 3C, the main difference between the first electrode 400b of the embodiment and the first electrode 400a is that a finger 410b includes two strip regions 412 and a bending region 414 located between the two strip regions.

In detail, the second edge E2 of the opening region OR of the light-shielding layer BM, for example, is presented as a V shape in the direction Z. Therefore, the two strip regions 412 corresponding to the same subpixels SP may have different extension directions from each other, and the bending region 414 is configured to connect one end of each of the two strip regions 412 to form the corresponding finger 410b. In some embodiments, the finger portion 410b corresponding to each subpixel includes the two strip regions 412 with different extension directions and the bending region 414 located between the two strip regions 412, and different subpixels may correspond to the same fingers 410b, but the disclosure is not limited thereto.

In the embodiments shown in FIG. 3B and FIG. 3C, when the voltage is not applied to the display panel 100, a long axis direction of the liquid crystal molecules (not shown) is substantially parallel to the direction X, and when the voltage is applied to the display panel 100, the liquid crystal molecules may be deflected according to the direction of the electric field, allowing the light to pass through and present an image. The direction of the electric field may be substantially parallel to the arrangement direction of the plurality of fingers 410a (the plurality of fingers 410b) of the first electrode 400a (the first electrode 400b). In the present embodiment, the direction of the electric field is substantially the direction Y, but the disclosure is not limited thereto.

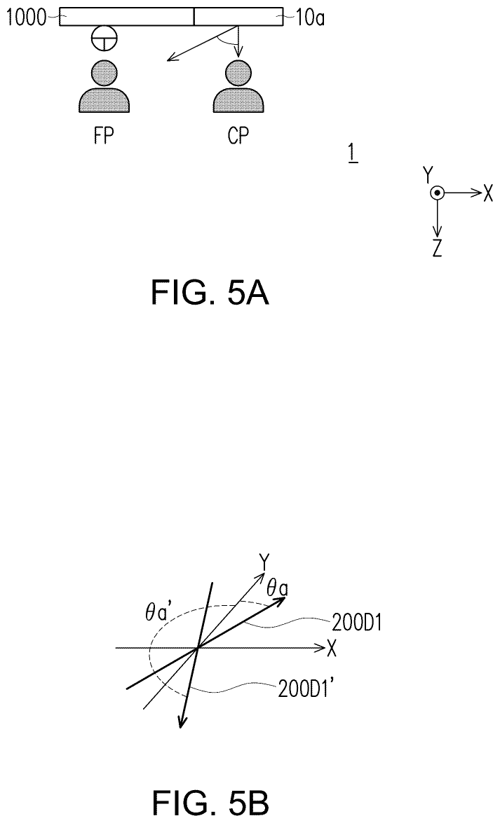

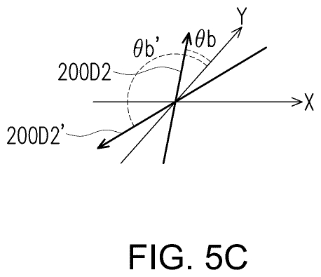

FIG. 5A is a schematic diagram of a vehicle display including a display device of an embodiment of the disclosure, FIG. 5B shows a schematic diagram of an embodiment of a direction of liquid crystal director of a viewing angle control panel in a vehicle display, and FIG. 5C shows a schematic diagram of another embodiment of a direction of liquid crystal director of a viewing angle control panel in a vehicle display.

Please refer to FIG. 5A. FIG. 5A shows the vehicle display 1 applied to left-hand drive vehicles, which includes the display device 10a of the embodiment and another display device 1000, wherein the display device 1000 is disposed on the left side of the display device 10a in the embodiment, but the disclosure is not limited thereto. The display device 10a of the embodiment includes, for example, a co-driver display disposed in front of a co-pilot CP, and the display device 1000 includes, for example, a center information display and an instrument cluster disposed in front of a driver FP, but the disclosure is not limited thereto. In some embodiments, the viewing angle control panel 200 in the display device 10a may have a direction of liquid crystal director 200D1 or a direction of liquid crystal director 200D1′ as shown in FIG. 5B. Please refer to FIG. 5B. In some embodiments, an angle θa is an angle between the direction of liquid crystal director 200D1 and the direction Y (the extension direction of the first edge E1 of the opening region OR), and the angle θa is defined as the angle obtained by rotating clockwise from the direction Y to the direction of liquid crystal director 200D1, but the disclosure is not limited thereto. In some embodiments, the angle θa between the direction of liquid crystal director 200D1 and the extension direction of the first edge E1 of the opening region OR is, for example, from −25° to 0°, or from −15° to 0°. In other embodiments, an angle θa′ is an angle between the direction of liquid crystal director 200D1′ and the direction Y (the extension direction of the first edge E1 of the opening region OR), and the angle θa′ is defined as the angle obtained by rotating counterclockwise from the direction Y to the direction of liquid crystal director 200D1′, but the disclosure is not limited thereto. In some embodiments, the angle θa′ between the direction of liquid crystal director 200D1′ and the extension direction of the first edge E1 of the opening region OR is, for example, from 180° to 205°, or from 180° to 195°.

In other embodiments, the vehicle display 1 may be applied to right-hand drive vehicles. That is, the display device 1000 is disposed to the right of the display device 10a in the embodiment. Please refer to FIG. 5C. In some embodiments, the viewing angle control panel 200 in the display device 10a may have a direction of liquid crystal director 200D2 or a direction of liquid crystal director 200D2′ as shown in FIG. 5C. In some embodiments, an angle θb is an angle between the direction of liquid crystal director 200D2 and the direction Y (the extension direction of the first edge E1 of the opening region OR), and the angle θb is defined as the angle obtained by rotating counterclockwise from the direction Y to the direction of liquid crystal director 200D2, but the disclosure is not limited thereto. In some embodiments, the angle θb between the direction of liquid crystal director 200D2 and the extension direction of the first edge E1 of the opening region OR is, for example, from 0° to 25°, or from 0° to 15°. In other embodiments, the angle θb′ is the angle between the direction of liquid crystal director 200D2′ and the direction Y (the extension direction of the first edge E1 of the opening region OR), and the angle θb′ is defined as the angle obtained by rotating counterclockwise from the direction Y to the direction of liquid crystal director 200D2′, but the disclosure is not limited thereto. In some embodiments, the angle θb′ between the direction of liquid crystal director 200D2′ and the extension direction of the first edge E1 of the opening region OR is, for example, from 155° to 180°, or from 165° to 180°.

In the vehicle display 1 shown in the above embodiment, by designing the relationship of the angle between the direction of liquid crystal director 200D1, the direction of liquid crystal director 200D1′, the direction of liquid crystal director 200D2 and the direction of liquid crystal director 200D2′, and the direction Y (the extension direction of the first edge E1 of the opening region OR), the privacy capability of the vehicle display 1 at a relatively small viewing angle may be improved to reduce the possibility that the picture displayed by the display device 10a may affect driving.

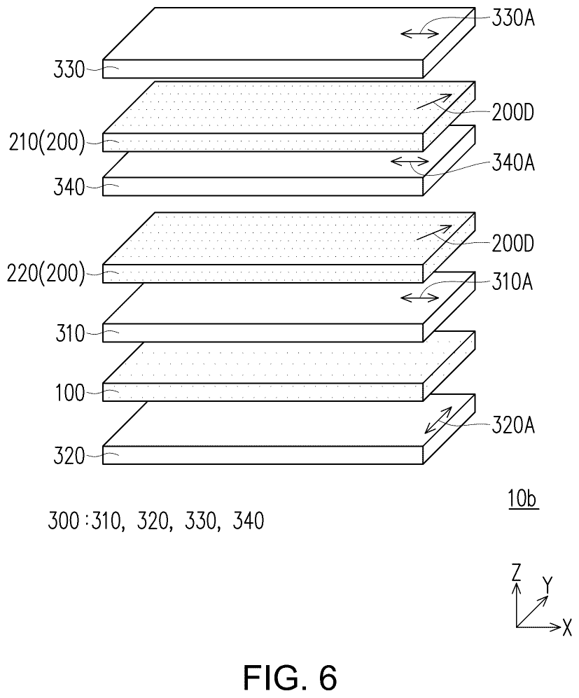

FIG. 6 is an exploded perspective schematic diagram of a display device of the second embodiment of the disclosure. It should be noted that the embodiment of FIG. 6 can use the reference numbers and part of the content of the embodiment of FIG. 1, wherein the same or similar numbers are used to represent the same or similar elements, and the description of the same technical content is omitted.

Please refer to FIG. 6. The main difference between a display device 10b of the embodiment and the display device 10a is that the second viewing angle control panel 220 is disposed between the display panel 100 and the first viewing angle control panel 210.

In the embodiment, the display panel 100 is far away from users relative to the first viewing angle control panel 210 and the second viewing angle control panel 220. That is, the first viewing angle control panel 210 and the second viewing angle control panel 220 are disposed above the display panel 100. In some embodiments, the first viewing angle control panel 210 and the second viewing angle control panel 220 may have different phase delays. For example, the phase delay of the first viewing angle control panel 210 may be greater than the phase delay of the second viewing angle control panel 220 to improve the privacy capability of the first viewing angle control panel 210 at a relatively small viewing angle, but the disclosure is not limited thereto.

In the embodiment, since the third polarizing plate 330, the fourth polarizing plate 340, and the first polarizing plate 310 are located on the same side of the display panel 100, the absorption axis 330A of the third polarizing plate 330 and the absorption axis 340A of the fourth polarizing plate 340 are, for example, parallel to the absorption axis 310A of the first polarizing plate 310. In other words, the absorption axis 330A of the third polarizing plate 330 and the absorption axis 340A of the fourth polarizing plate 340 are parallel to the direction X, but the disclosure is not limited thereto.

In other embodiments, the display panel 100 may be disposed between the first viewing angle control panel 210 and the second viewing angle control panel 220. The first viewing angle control panel 210 is closer to users than the second viewing angle control panel 220. Based on this, in some embodiments, the first viewing angle control panel 210 and the second viewing angle control panel 220 may have different phase delays. In detail, the phase delay of the first viewing angle control panel 210 may be, for example, greater than the phase delay of the second viewing angle control panel 220 to improve the privacy capability of the first viewing angle control panel 210 at a relatively small viewing angle, but the disclosure is not limited thereto.

FIG. 7 is a partial top schematic diagram of another embodiment of the region R according to FIG. 1. It should be noted that the embodiment of FIG. 7 can use the reference numbers and part of the content of the embodiment of FIG. 3B, wherein the same or similar numbers are used to represent the same or similar elements, and the description of the same technical content is omitted.

Referring to FIG. 7, in the present embodiment, the display panel 100 includes a plurality of transistors T, a plurality of scan lines SL, a plurality of data lines DL, and a first electrode 400c.

One of the plurality of transistors T includes a gate G, a source S, a drain D, and a semiconductor layer SE. The other introduction pertaining the gate G, the source S, the drain D and the semiconductor layer SE can refer to the above embodiment, and will be omitted herein.

From a macro perspective, the plurality of scan lines SL substantially extend in a direction X, and the plurality of data lines DL substantially extend in a direction Y, and the direction X is perpendicular (or is interlaced) to the direction Y. In the present embodiment, two adjacent scan lines SL and two adjacent data lines DL can define a subpixel SP of the display device 10c, but the disclosure is not limited thereto. The other introduction about the scan lines SL and the data lines DL can refer to the above embodiments and will be omitted herein.

In the present embodiment, the first electrode 400c may be used as a common electrode, but the disclosure is not limited thereto. In other embodiments, the first electrode 400c may be used as a pixel electrode. The material of the first electrode 400c can refer to the above embodiment and will be omitted herein.

In the present embodiment, the first electrode 400c has a plurality of fingers 410c. The plurality of fingers 410c are arranged along the direction Y. In some embodiments, the plurality of fingers 410c corresponding to the same subpixels SP may comprise a first finger 410c1 and a second finger 410c2, wherein an angle α between an extension direction of a strip region 412c1 in the first finger 410c1 and the direction X ranges from 3° to 15° (calculated from the direction X rotating along the counterclockwise direction until the extension direction of the strip region 412c1), and an angle α between a strip region 412c2 in the second fingers 410c2 and the direction X ranges from −3° to −15° (calculated from the direction X rotating along the clockwise direction until the extension direction of the strip region 412c2). From another perspective, the strip region 412c1 of the first finger 410c1 and the strip region 412c2 of the second finger 410c2 corresponding to the same subpixels SP may have the different extension directions on the XY plane. In some embodiments, the plurality of fingers 410c corresponding to each subpixel SP include at least two strip regions 412c1 and 412c2 with the different extension directions, and the different subpixels SP may correspond to the same fingers 410c, but the disclosure is not limited thereto.

In the present embodiment, at least one of the plurality of opening regions OR of the light-shielding layer BM has two first edges E1 and two second edges E2. The two first edges E1 correspond to each other and extend along the direction Y, and the two second edges E2 correspond to each other and extend along the direction X. The first edge E1 has a first length L1, and the first length L1 is greater than or equal to 30 μm and less than or equal to 210 μm. The first distance D1 between the two first edges E1 is greater than or equal to 10 μm and less than or equal to 70 μm. In the present embodiment, the first distance D1 may be the length of the second edge E2.

In the present embodiment, when the voltage is not applied to the display panel 100, the long axis direction of the liquid crystal molecules (not shown) is substantially parallel to the direction X, and when the voltage is applied to the display panel 100, the liquid crystal molecules may be deflected according to the direction of the electric field, so that the light can pass through and present an image. The direction of the electric field may be substantially parallel to the arrangement direction of the plurality of fingers 410c of the first electrode 400c. In the present embodiment, the direction of the electric field is substantially the direction Y, but the disclosure is not limited thereto.

FIG. 8 is an exploded perspective schematic diagram of a display device of the third embodiment of the disclosure. It should be noted that the embodiment of FIG. 8 can use the reference numbers and part of the content of the embodiment of FIG. 1, wherein the same or similar numbers are used to represent the same or similar elements, and the description of the same technical content is omitted.

Referring to FIG. 8, the main difference between the display device 10c and the above display device 10a is that the display device 10c further includes a backlight module 500. The backlight module 500 can also be applied in the display device 10b shown in FIG. 6.

In the present embodiment, the backlight module 500 includes a light source 510 and a plurality of optical films. The optical film may be single optical films or composite optical films. As shown in FIG. 8, the plurality of optical films includes a diffuser 520, a first brightness enhancement film 530, a second brightness enhancement film 540, a third brightness enhancement film 550 and a light control film 560, wherein the diffuser 520, the first brightness enhancement film 530, the second brightness enhancement film 540, the third brightness enhancement film 550 and the light control film 560 are stacked in this order in the direction Z, but the disclosure is not limited thereto. The light source 510 can be disposed below or disposed on the side of the diffuser 520, but the disclosure is not limited thereto.

The light source 510 located in the backlight module 500 is used to provide the light. In some embodiments, the light source 510 may provide the light to a light guide plate (not shown), so that the light may be transmitted in the light guide plate and be provided to the display panel 100 and/or the viewing angle control panel 200. In some embodiments, the light source 510 may include a plurality of light emitting diodes, wherein the driving method of the light emitting diodes may include passive matrix addressing, active matrix addressing, or control by an integrated circuit, but the disclosure is not limited thereto.

The diffuser 520 is used to diffuse the light provided by the light source 510 and may have high light transmittance. The first brightness enhancement film 530, the second brightness enhancement film 540, and the third brightness enhancement film 550 may have the effect of concentrating and brightening the light. In the present embodiment, the first brightness enhancement film 530 and the second brightness enhancement film 540 may include prism sheets, and the third brightness enhancement film 550 may include a dual brightness enhancement film (DBEF), but the disclosure is not limited thereto. Based on the above, the light passing through the diffuser 520 can be deflected to the direction Z via the first brightness enhancement film 530 and the second brightness enhancement film 540, and the light not parallel to the polarization direction of the third brightness enhancement film 550 (or not parallel to the transmission axis of the third brightness enhancement film 550) can be reflected to be reused. Therefore, the utilization efficiency of the light could be improved.

The light control film (LCF) 560 may be used to limit the direction of the light passing through the third brightness enhancement film 550, so that the light is further collimated when being provided to the display panel 100 and/or the viewing angle control panel 200. In the present embodiment, the light-controlling film 560 has a plurality of light-shielding patterns 562 spaced apart from each other, and the light-shielding patterns 562 extend along a direction D1, but the disclosure is not limited thereto. In some embodiments, the light control film 560 and the third brightness enhancement film 550 may be combined to form a composite film material, but the disclosure is not limited thereto.

In some embodiments, an absolute value of the angle between the polarization direction of the third brightness enhancement film 550 (or the transmission axis of the third brightness enhancement film 550) and the polarization direction of the adjacent polarizing plate (which may be the transmission axis of the fourth polarizing plate 340 or the transmission axis of the second polarizing plate 320 shown in FIG. 6) is greater than or equal to 0 degree and less than or equal to 15 degrees (calculated from the polarization direction of the adjacent polarizing plate rotating along the counterclockwise direction or the clockwise direction until the polarization direction of the third brightness enhancement film 550), and an absolute value of the angle between the polarization direction of the third brightness enhancement film 550 and the extension direction (the direction D1) of the plurality of light-shielding patterns 562 of the light control film 560 is greater than or equal to 0 degree and less than or equal to 15 degrees (calculated from the direction D1 rotating along the counterclockwise direction or the clockwise direction until the polarization direction of the third brightness enhancement film 550). In some embodiments, the polarization direction of the third brightness enhancement film 550 is substantially parallel to the extension direction (direction D1) of the plurality of light-shielding patterns 562 of the light control film 560, but the disclosure is not limited thereto. The above design is helpful to reduce the light loss provided by the backlight module 500 to the display panel 100 and/or the viewing angle control panel 200.

In the present embodiment, there is an angle θ3 between the extending direction (the direction D1) of the plurality of light-shielding patterns 562 of the light control film 560 and the extending direction (the direction Y) of the first edge E1 of the light-shielding layer BM of the display panel 100, wherein an absolute value of the angle θ3 is greater than or equal to 80 degrees and less than or equal to 90 degrees. In some embodiments, when the display device is applied to a left-hand drive vehicle, the angle θ3 may be greater than or equal to −90 degrees and less than or equal to −80 degrees (calculated from the direction Y rotating along the clockwise direction until the direction D1), but the disclosure is not limited thereto. In some embodiments, when the display device is applied to a right-hand drive vehicle, the angle θ3 may be greater than or equal to 80 degrees and less than or equal to 90 degrees (calculated from the direction D1 rotating along the counterclockwise direction until the direction Y), but the disclosure is not limited thereto. From another perspective, there is an included angle θ4 between the extending direction (the direction D1) of the plurality of light-shielding patterns 562 of the light control film 560 and the extending direction (the direction X) of the second edge E2 of the light-shielding layer BM of the display panel 100, and an absolute value of the angle θ4 may be greater than or equal to 0 degree and less than or equal to 10 degrees. In some embodiments, when the display device is applied to the left-hand drive vehicle, the angle θ4 is greater than or equal to 0 degree and less than or equal to 10 degrees (calculated from the direction X rotating along the counterclockwise direction until the direction D1), but the disclosure is not limited thereto. In some embodiments, when the display device is applied to the right-hand drive vehicle, the angle θ4 is greater than or equal to −10 degrees and less than or equal to 0 degree (calculated from the direction X rotating along the clockwise direction until the direction D1), but the disclosure is not limited thereto. The above design can reduce the possibility of moiré patterns generated from the display device, thereby improving the display quality of the display device 10c. In some embodiments, when an absolute value of the angle θ4 between the extension direction (direction D1) of the plurality of light-shielding patterns 562 of the light control film 560 and the direction X is greater than or equal to 0 degree and less than or equal to 10 degrees, it is advantageous to place the display device under the windshield, but the disclosure is not limited thereto. The above design can reduce the chance of light from the display device being projected onto the windshield and then reflected into the eyes of driver, thereby improving driving safety.

In the present embodiment, the first brightness enhancement film 530 and the second brightness enhancement film 540 may respectively include a plurality of microstructures 532 and a plurality of microstructures 542, wherein the plurality of microstructures 532 extend along a direction D3, the plurality of microstructures 542 extend along a direction D2, and the direction D3 is perpendicular to the direction D2. In the present embodiment, the second brightness enhancement film 540 is disposed between the first brightness enhancement film 530 and the light control film 560, and there is an angle θ5 between the extension direction (the direction D2) of the plurality of microstructures 542 of the second brightness enhancement film 540 and the extension direction (the direction D1) of the plurality of light-shielding patterns 562 of the light control film 560, and an absolute value of the angle θ5 is greater than or equal to 0 degree and less than or equal to 15 degrees (calculated from the direction D1 rotating along the counterclockwise direction or the clockwise direction until the direction D2). The above design is beneficial for providing the display device 10c to have a wide viewing angle.

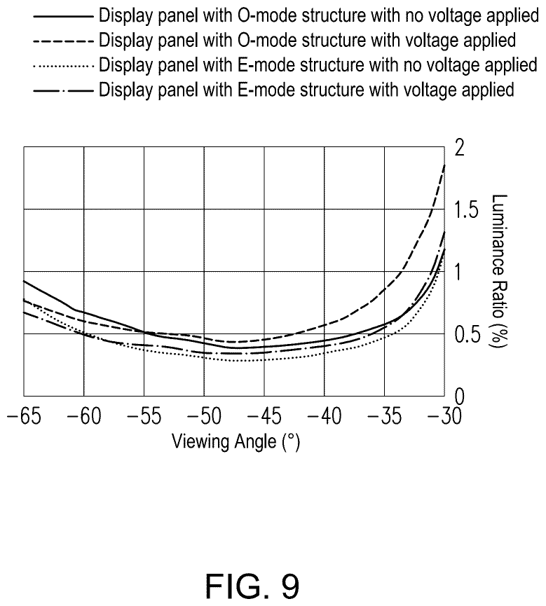

FIG. 9 is a curve diagram showing a relationship between a viewing angle of the display device and a luminance ratio in an E-mode structure and an O-mode structure according to an embodiment of the disclosure.

FIG. 9 shows the luminance ratio of a display panel with an E-mode structure and a display panel with an O-mode structure when viewed at different viewing angles with no voltage applied and with voltage applied, wherein the luminance ratio is defined as the percentage of the luminance of the display device measured or viewed at the certain viewing angle in the privacy mode to the luminance of the display device measured or viewed at the normal viewing angle perpendicular to the display device (direction Z). Referring to FIG. 9, it can be seen that the display panel with the E-mode structure has a smaller difference in the luminance ratio after the voltage is applied when compared with that of the display panel with the O-mode structure. Therefore, in the privacy mode, the display panel with the E-mode structure is less likely to be affected or invalidated due to the voltage change or switching of the display panel.

In detail, in the display panel with the E-mode structure, the absorption axis direction of the polarizing plate located below the display panel is perpendicular to the long axis direction of the liquid crystal molecules of the display panel to which no voltage is applied (or the absorption axis direction of the polarizing plate located below the display panel is parallel to the direction of electric field after the voltage is applied). For example, if the absorption axis direction of the polarizing plate located below the display panel is a vertical direction, the long axis direction of the liquid crystal molecules of the display panel to which no voltage is applied is a horizontal direction, and the direction of electric field after the voltage is applied is the vertical direction.

Based on the above, after the voltage is applied to the display panel with the E-mode structure, the difference of periodic refractive index of the liquid crystal molecules in the horizontal direction is smaller. Therefore, compared with the display panel with the O-mode structure, when the light passes through the display panel with the E-mode structure, the light can have a weaker scattering effect in the horizontal direction, thereby increasing the privacy capability of the display device in the horizontal direction.

In the present embodiment, the display device 10a, the display device 10b, and the display device 10c all include the display device with the E-mode architecture, wherein the display panel with the E-mode structure may be the display panel 100 shown in FIG. 3A, FIG. 3B, FIG. 3C and FIG. 7. Based on the above, the display device 10a, the display device 10b and the display device 10c of the present embodiment can have an improved privacy capability in the privacy mode.

In summary, in the display device provided by some embodiments of the disclosure, by enabling the subpixels included in the pixels to be presented as a vertically arranged design, one pixel may have one single scattering source in the direction X, thereby reducing the occurrence of diffraction phenomena and increasing the privacy capability of the display device of the disclosure. Furthermore, by limiting the angle between the direction of liquid crystal director of the viewing angle control panel and the direction Y, the privacy capability of the display device of the disclosure at a relatively small viewing angle may be improved to reduce the possibility of affecting the driver when the display device of the disclosure is applied to a vehicle display.

In addition, in the display device provided in some embodiments of the disclosure, by making the display device of the present embodiment have the display panel with the E-mode structure, the probability of the privacy capability being affected or failing in the privacy mode can be further reduced.

What is claimed is:

1. A display device, comprising:
a display panel, comprising a light-shielding layer, the light-shielding layer having a plurality of opening regions, wherein at least one of the plurality of opening regions has two first edges, and the two first edges correspond to each other and extend along a first direction; and
a viewing angle control panel, overlapping the display panel and having a direction of liquid crystal director, wherein an angle between the direction of liquid crystal director and the first direction is from −25° to 25° or from 155° to 205°,
wherein one of the two first edges has a first length, a spacing between the two first edges is a first distance, and the first length is less than the first distance.

2. The display device according to claim 1, wherein the display panel further comprises:
a data line, extending along a first direction;
a scan line, extending along a second direction and intersecting with the data line; and
a first electrode having a plurality of fingers, wherein the plurality of fingers are arranged along the first direction, at least one of the plurality of fingers has a strip region, and the strip region is parallel to at least one of the plurality of scan lines.

3. The display device according to claim 1, wherein the display panel further comprises:
a first polarizing plate, disposed on a surface opposite to a light-emitting surface of the display panel and having a first absorption axis, wherein the first absorption axis is parallel to the first direction.

4. The display device according to claim 3, wherein the display panel further comprises:
a liquid crystal molecule, a long axis direction of the liquid crystal molecules to which no voltage is applied is perpendicular to the first absorption axis.

5. The display device according to claim 1, wherein the display panel comprises a first subpixel and a second subpixel, and the plurality of opening regions comprise a first opening region and a second opening region, wherein the first opening region corresponds to the first subpixel, the second opening region corresponds to the second subpixel, and the first opening region and the second opening region are arranged along the first direction, wherein the first subpixel and the second subpixel emit different colors.

6. The display device according to claim 1, further comprising a backlight module, wherein the backlight module comprises a light source, a diffuser, a first brightness enhancement film, a second brightness enhancement film, a third brightness enhancement film and a light control film, wherein the diffuser, the first brightness enhancement film, the second brightness enhancement film, the third brightness enhancement film and the light control film are stacked in this order in a third direction, wherein the third direction is perpendicular to the first direction.

7. The display device according to claim 1, configured to be disposed in a left-hand drive vehicle, wherein the angle between the direction of liquid crystal director and the first direction is from −25° to 0° or from 180° to 205°.

8. The display device according to claim 1, configured to be disposed in a right-hand drive vehicle, wherein the angle between the direction of liquid crystal director and the first direction is from 0° to 25° or from 155° to 180°.

9. A display device, comprising:
a display panel, comprising:
a data line, extending along a first direction;
a scan line, extending along a second direction and intersecting with the data line; and
a first electrode having a plurality of fingers, wherein the plurality of fingers are arranged along the first direction;
a viewing angle control panel, overlapping the display panel; and
a first polarizing plate, disposed on a surface opposite to a light-emitting surface of the display panel and having a first absorption axis, wherein the first absorption axis is parallel to the first direction.

10. The display device according to claim 9, wherein the display panel further comprises:
a liquid crystal molecule, a long axis direction of the liquid crystal molecules to which no voltage is applied is perpendicular to the first absorption axis.

11. The display device according to claim 9, wherein a direction of an electric field of the display panel after a voltage is applied is parallel to the first absorption axis.

12. The display device according to claim 9, further comprising a backlight module, wherein the backlight module comprises a light control film, wherein the light control film has a plurality of light-shielding patterns spaced apart from each other, and the plurality of light-shielding patterns extend along a third direction, wherein the third direction is different from the first direction, and the third direction is different from the second direction.

13. The display device according to claim 12, wherein an absolute value of an angle between the third direction and the first direction is greater than or equal to 80 degrees and less than or equal to 90 degrees.

14. The display device according to claim 12, wherein the backlight module comprises a first brightness enhancement film and a second brightness enhancement film, the first brightness enhancement film, the second brightness enhancement film and the light control film are stacked in this order in a fourth direction, wherein the fourth direction is perpendicular to the first direction, the second direction and the third direction.

15. The display device according to claim 14, wherein the second brightness enhancement film comprises a plurality of microstructures, the plurality of microstructures extend along a fifth direction, and an absolute value of an angle between the fifth direction and the third direction is greater than or equal to 0 degree and less than or equal to 10 degrees.

16. The display device according to claim 9, wherein the plurality of fingers comprises a first finger and a second finger, a strip region of the first finger has a first extension direction, a strip region of the second finger has a second extension direction, and the first extension direction is different from the second extension direction.

17. The display device according to claim 9, wherein at least one of the plurality of fingers has a strip region, and an absolute value of an angle between an extension direction of the strip region and the second direction ranges is greater than or equal to 3 degrees and less than or equal to 15 degrees.

18. The display device according to claim 9, wherein at least one of the plurality of fingers has a first strip region, a second strip region and a bending region, the bending region is located between the first strip region and the second strip region, and an extension direction of the first strip region is different from an extension direction of the second strip region.

19. The display device according to claim 9, further comprising another viewing angle control panel, wherein the viewing angle control panel overlaps with the another viewing angle control panel.

20. The display device according to claim 19, further comprising:
a second polarizing plate, disposed on the light-emitting surface of the display panel;
a third polarizing plate, disposed on a surface of the viewing angle control panel away from the display panel; and
a fourth polarizing plate, disposed on a surface of the another viewing angle control panel away from the display panel.
